(19) United States
(12) Patent Application Publication
(10) Pub. No.: US 2020/0380101 A1
(43) Pub. Date: Dec. 3, 2020

(54) REGISTRATION APPARATUS, AUTHENTICATION APPARATUS, PERSONAL AUTHENTICATION SYSTEM, AND PERSONAL AUTHENTICATION METHOD, AND PROGRAM AND RECORDING MEDIUM

(71) Applicant: MITSUBISHI ELECTRIC CORPORATION, Tokyo (JP)

(72) Inventor: Shiori ARII, Tokyo (JP)

(73) Assignee: MITSUBISHI ELECTRIC CORPORATION, Tokyo (JP)

(21) Appl. No.: 16/497,093

(22) PCT Filed: Mar. 31, 2017
(86) PCT No.: PCT/JP2017/013579

§ 371 Date: Sep. 24, 2019

(51) Int. Cl. G06F 21/32; G06N 3/08; G06N 3/04

(52) U.S. Cl. CPC G06F 21/32; G06N 3/0445; G06N 3/0454; G06N 3/08

(57) ABSTRACT

In a personal authentication system based on seat pressure, a registration apparatus adjusts parameters by means of feature computation using, as training data, a time series pressure distribution data piece of a would-be registrant and time series pressure distribution data pieces of a plurality of other persons, and back propagation based on a difference between the results of the feature computation and training signals, and stores the adjusted parameters as a personal identification data piece. The authentication apparatus determines the personal identification value by means of computation on a time series pressure distribution data piece of an authentication object person, using, as parameters, a personal identification data piece for each registered person, and performs authentication. The feature computation includes computations for extracting a physical feature and a behavioral feature. It is possible to perform registration of a personal identification data piece, or personal authentication based on data obtained when the user is behaving naturally.

### TECHNICAL FIELD

The present invention relates to a registration apparatus for registering a personal identification data piece, and an authentication apparatus for performing personal authentication. The present invention also relates to a personal authentication system having the above-mentioned registration apparatus and the above-mentioned authentication apparatus. Further, the present invention relates to a personal authentication method, as well as a program and a recording medium.

### BACKGROUND ART

Personal authentication techniques include those utilizing a knowledge attribute such as a password, those utilizing a possession attribute such as a card or a key, and those utilizing a biometric attribute such as a biometric feature. The personal authentication utilizing a biometric attribute is called biometric authentication, and has an advantage of a lower possibility of theft or forging over other types of personal authentication schemes. Biometric features utilized in biometric authentication include physical features in the static state of the body, and behavioral features related to motion of the body. An example of the authentication technique using the physical feature is shown in Patent reference 1, and examples of the authentication technique using a behavioral feature quantity are shown in Patent references 2 and 3.

Patent reference 1 discloses storing pressure distribution data when a user is seated, and comparing, with the stored data, pressure distribution data of the user upon being seated again, after leaving, to perform authentication of the user.

Patent reference 2 discloses determining a plurality feature quantities from pressure values at a plurality of different positions on a seat surface of a chair for each of a plurality of users, registering a set of correlation coefficients between feature quantities in association with each user, calculating Mahalanobis' distance of a tested person, from the plurality of feature quantities determined for the tested person in the same manner, and the set of correlation coefficients for each of the plurality of registered users, and determining which of the registered users the tested person is, from the calculated Mahalanobis' distances.

Patent reference 3 describes a technique of detecting the pressure on the sole during walking, by means of a pressure sensor, obtaining the movement of the center of gravity at a plurality of timings from the landing of the sole to the leaving of the sole, as a physical feature, and extracting the personal feature.

### PRIOR ART REFERENCES

### Patent References

[Patent reference 1] Patent publication No. 2007-179422 (Paragraph 0022)

[Patent reference 2] Patent publication No. 2012-133683 (Paragraphs 0032, 0039, 0044, 0046, 0050, 0051, 0055)

[Patent reference 3] Patent publication No. 2015-52999 (Abstract, Paragraphs 0020 to 0028)

### SUMMARY OF THE INVENTION

### Problems to be Solved by the Invention

A conventional personal authentication based on biometric pressure information uses a physical feature or a behavioral feature for authentication, and the method of extracting such a feature is selected based on statistical results. However, the authentication by means of a physical feature is associated with a problem in that the accuracy of authentication may be lowered by the weight of the user, change in the body shape of the user, or the position at which the user is seated. The authentication by means of a behavioral feature is associated with a problem that it is affected by the manner of motion of the user, or the environment in which the measurement is performed. To solve the problems mentioned above, various methods for extracting a physical feature or a behavioral feature have been studied. Whether each method of feature extraction is suitable or not is evaluated based on whether or not accurate authentication results are obtained statistically, and objective evaluation is difficult. Also, it is necessary to impose restrictions on the motion or the like of the user (the person who is to be registered or authenticated) at the time of measurement, in order to avoid influence of information other than the feature of the individual.

An object of the present invention is to enable registration of a personal identification data piece, or personal authentication based on data obtained when the user is seated in a natural manner, without imposing restrictions on the motion of the user.

### Means for Solving the Problem

A registration apparatus according to the present invention comprises:

a pressure sensor disposed on a seat surface on which a person sits, and detecting distribution of pressure applied on the seat surface, and outputting pressure distribution data of respective frames;

a data converter for outputting a time series of the pressure distribution data of respective frames outputted from the pressure sensor, as a time series pressure distribution data piece;

a learning data storage unit for storing time series pressure distribution data pieces pertaining to a plurality of randomly selected persons;

a preprocessor for generating a set of training data, using, as the training data, a time series pressure distribution data piece pertaining to a user to be registered, and a plurality of time series pressure distribution data pieces pertaining to persons other than the user to be registered, stored in the learning data storage unit, and also generating a set of training signals corresponding to the set of training data;

a parameter storage unit for storing a set of parameters;

a feature computation unit for sequentially selecting the training data included in the set of training data generated by the preprocessor, performing feature computation on the selected training data, using the set of parameters stored in the parameter storage unit, and sequentially outputting results of the computation;

a learning unit for adjusting, through learning, the set of parameters based on a set of the results of the computation sequentially outputted from the feature computation unit, and the set of training signals generated by the preprocessor;

an identification data generation unit for generating a personal identification data piece pertaining to the user from the set of parameters adjusted by the learning unit; and

an identification data storage unit for storing the personal identification data piece generated by the identification data generation unit, in association with information specifying the user, thereby to register the user; wherein

the feature computation unit performs computation for extracting a physical feature from the pressure distribution data of each frame, and computation for extracting a behavioral feature from the time series of the pressure distribution data.

An authentication apparatus according to the present invention comprises:

an identification value generation unit for performing feature computation on a time series pressure distribution data piece pertaining to an authentication object person, using, as a set of parameters, the personal identification data piece pertaining to the user registered in the identification data storage unit in the above-mentioned registration apparatus, calculating, from a result of the feature computation, a personal identification value representing probability that the authentication object person is identical to the registered user, and outputting the calculated personal identification value,

the feature computation performed by the identification value generating unit being identical to the feature computation performed by the feature computation unit in the registration apparatus; and

an authentication decision unit for determining that the authentication object person is identical to the registered user, when the personal identification value outputted from the identification value generation unit is larger than a predetermined authentication threshold value.

A personal authentication system according to the present invention comprises the above-mentioned registration apparatus and the above-mentioned authentication apparatus.

A personal authentication method according to the present invention is a personal authentication method A personal authentication method for performing personal authentication based on a time series pressure distribution data piece comprising a time series of pressure distribution data of respective frames obtained by detecting distribution of pressure applied on a seat surface on which a person sits, the method comprising:

storing, in a learning data storage unit, time series pressure distribution data pieces pertaining to a plurality of randomly selected persons;

generating a set of training data using, as the training data, a time series pressure distribution data piece pertaining to a user to be registered, and a plurality of time series pressure distribution data pieces pertaining to persons other than the user to be registered, stored in the learning data storage unit;

generating a set of training signals corresponding to the set of training data;

storing a set of parameters in a parameter storage unit;

sequentially selecting the training data included in the set of training data,

performing feature computation on the selected training data, using the set of parameters stored in the parameter storage unit, to sequentially generate results of the computation;

adjusting, through leaning, the set of parameters based on a set of the sequentially generated results of the computation, and the set of training signals;

storing, in an identification data storage unit, the adjusted set of parameters as a personal identification data piece of the user, in association with information specifying the user, thereby to register the user;

the feature computation including computation for extracting a physical feature from the pressure distribution data of each frame, and computation for extracting a behavioral feature from the time series of the pressure distribution data,

performing feature computation identical to the feature computation performed on the training data, on a time series pressure distribution data piece pertaining to an authentication object person, using the personal identification data piece pertaining to the user registered in the identification data storage unit as a set of parameters;

calculating, from a result of the feature computation, a personal identification value representing probability that the authentication object person is identical to the registered user; and

determining that the authentication object person is identical to the registered user, when the calculated personal identification value is larger than a predetermined authentication threshold value.

### Effect of the Invention

According to the present invention, it is possible to perform registration of a personal identification data piece or personal authentication based on data obtained when the user is behaving naturally, without imposing restrictions on the motion of the user.

### BRIEF DESCRIPTION OF THE DRAWINGS

FIG. 1 is a functional block diagram showing a configuration of a personal authentication system of a first embodiment of the present invention.

FIG. 2 is a functional block diagram showing details of a personal identification unit in FIG. 1.

FIG. 3 is a diagram showing an example of a pressure sensor shown in FIG. 1.

FIG. 4 is a diagram showing an example of an arrangement of button sensors in the pressure sensor, and an example of pressure values detected by the respective button sensors.

FIG. 5 is a diagram showing an example of a configuration of a computer system constituting the personal authentication system in FIG. 1.

FIG. 6 is a diagram showing an example of a configuration of a feature computation unit in FIG. 1.

FIG. 7 is a flowchart showing a procedure of processes in a registration apparatus in FIG. 1.

FIG. 8 is a flowchart showing a procedure of processes in an authentication apparatus in FIG. 1.

FIG. 9 is a flowchart showing a procedure of processes for updating a personal identification data piece in the registration apparatus in FIG. 1.

FIG. 10 is a functional block diagram showing a configuration of a personal authentication system of a third embodiment of the present invention.

### MODE FOR CARRYING OUT THE INVENTION

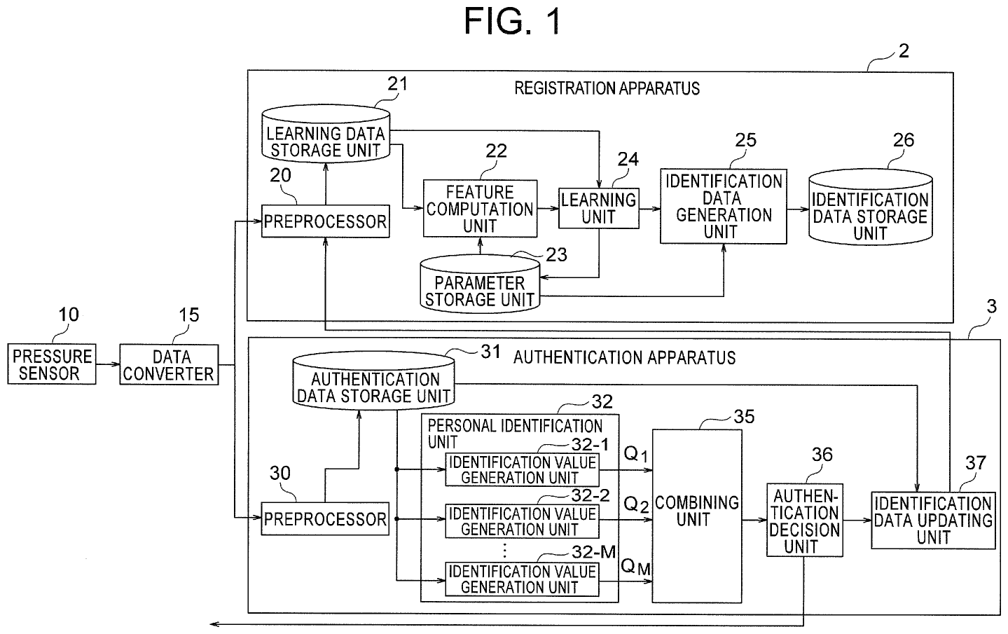

FIG. 1 is a functional block diagram showing a personal authentication system according to the present invention. The personal authentication system shown in FIG. 1 includes a pressure sensor 10, a data converter 15, a registration apparatus 2, and an authentication apparatus 3, and operates in a registration mode or in a personal authentication mode.

In the registration mode, the outputs of the data converter 15 are supplied to the registration apparatus 2. In the personal authentication mode, the outputs of the data converter 15 are supplied to the authentication apparatus 3.

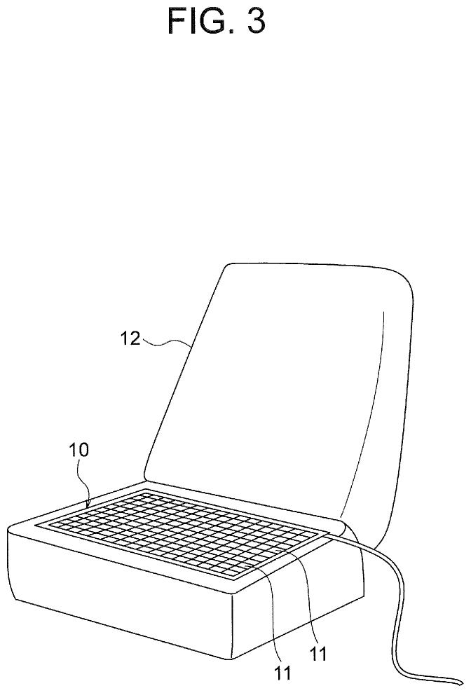

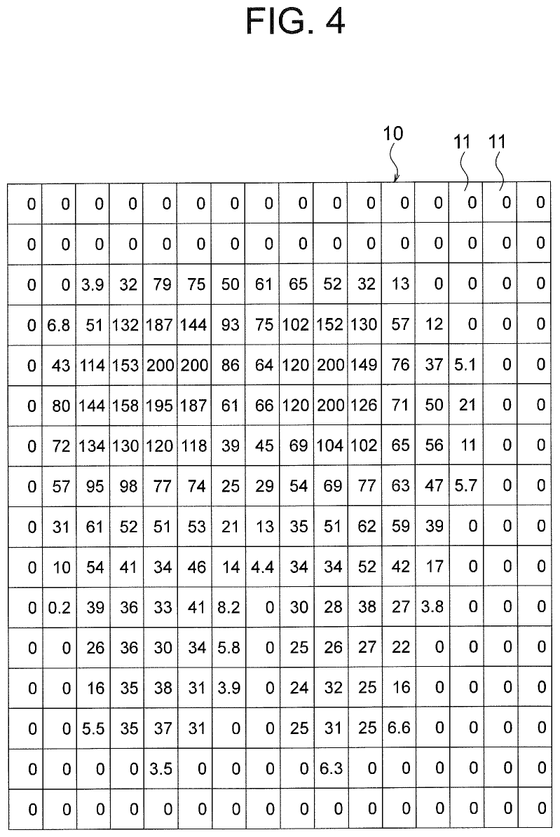

As shown in FIG. 3, the pressure sensor 10 is a sheet-shaped sensor (pressure sheet sensor) disposed on a seat surface of a chair 12. The pressure sensor 10 comprises a two-dimensional array of a plurality of button sensors 11, detects distribution of pressure applied on the seat surface when a person (user) is seated, and outputs pressure distribution data. For example, the plurality of button sensors 11 are aligned vertically and horizontally, as shown in FIG. 4. In the example shown in FIG. 4, the button sensors are aligned in 16 rows in the vertical direction, and in 16 columns in the horizontal direction. In FIG. 4, the numerical value written in each rectangular section representing each button sensor 11 indicates an example of a value of the pressure detected by the particular button sensor.

The pressure values are obtained every sampling period. An arrangement of pressure values detected by the respective button sensors 11 at a certain sampling timing, at the positions of the respective button sensors is called pressure distribution data of one frame.

The pressure distribution data of each frame represents pressure values at a plurality of points (positions of the button sensors) on a two-dimensional plane, and can be treated as three-dimensional data.

The data converter 15 receives the pressure distribution data outputted from the pressure sensor 10. Upon detecting that a user is seated}, the data converter 15 starts measurement for feature computation or identification value generation, and outputs a time series of pressure distribution data from the starting time point up to expiration of a preset measurement period, as a time series pressure distribution data piece. For example, the data converter 15 determines that a user is seated when a state in which the sum of the pressure values at each time point (sampling timing) is equal to or larger than a predetermined threshold value (pressure sum decision threshold value) continues for a predetermined time or longer.

In the registration mode, the user to be registered (would-be registrant) sits on the chair 12 provided with the pressure sensor 10, and a time series pressure distribution data piece of the user is input to the registration apparatus 2.

In the personal authentication mode, the user to be authenticated (authentication object person) sits on the chair 12 provided with the pressure sensor 10, and a time series pressure distribution data piece of the user is input to the authentication apparatus 3.

The registration apparatus 2 includes a preprocessor 20, a learning data storage unit 21, a feature computation unit 22, a parameter storage unit 23, a learning unit 24, an identification data generation unit 25, and an identification data storage unit 26.

The authentication apparatus 3 includes a preprocessor 30, an authentication data storage unit 31, a personal identification unit 32, a combining unit 35, an authentication decision unit 36, and an identification data updating unit 37.

Parts of the registration apparatus 2 and the authentication apparatus 3 in FIG. 1 (parts illustrated as functional blocks) and the data converter 15 can be implemented by a processing circuit. The processing circuit may be formed of dedicated hardware, or of a CPU executing programs stored in a memory.

For example, the function of each part in FIG. 1 may be implemented by a separate processing circuit. Alternatively, the functions of a plurality of parts may all be implemented by a single processing circuit.

When the processing circuit is formed of a CPU, the functions of the parts of the registration apparatus 2 and the authentication apparatus 3 are implemented by software, firmware, or a combination of software and firmware. The software or firmware may be described as a program, and stored in a memory. The processing circuit performs the functions of the respective parts by executing the programs stored in the memory.

Furthermore, a part of the functions of the respective parts of the registration apparatus 2 and the authentication apparatus 3 may be implemented by dedicated hardware, and another part may be implemented by software or firmware.

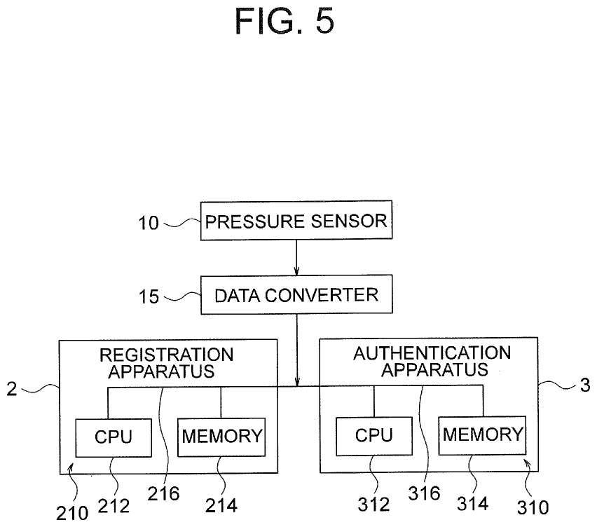

FIG. 5 shows an example of a configuration in which the above-mentioned processing circuit is a CPU, all the functions of the registration apparatus 2 are implemented by a computer (denoted by reference characters 210) including a single CPU, and all the functions of the authentication apparatus 3 are implemented by a computer (denoted by reference characters 310) including a separate single CPU, together with the pressure sensor 10 and the data converter 15.

The computer 210 shown in FIG. 5 includes a CPU 212, and a memory 214, which are connected via a bus 216 to the output of the data converter 15. The computer 310 includes a CPU 312 and a memory 314, which are connected via a bus 316 to the output of the data converter 15.

The CPU 212 operates according to the program stored in the memory 214, and performs the processes of each part of the registration apparatus 2 shown in FIG. 1 on the time series pressure distribution data piece input via the bus 216.

The CPU 312 operates according to the program stored in the memory 314, and performs the processes of each part of the authentication apparatus 3 shown in FIG. 1, on the time series pressure distribution data piece input via the bus 316.

The operation of the respective parts shown in FIG. 1 is now described.

Time series pressure distribution data pieces pertaining to a plurality of randomly selected persons (tested persons) are stored in advance in the learning data storage unit 21 in the registration apparatus 2.

The preprocessor 20 generates a set of training data from the time series distribution data piece outputted from the data converter 15 when a would-be registrant is seated, and the time series pressure distribution data pieces pertaining to a plurality of persons stored in the learning data storage unit 21. The generated set of training data comprises a time series distribution data piece pertaining to the would-be registrant, and a plurality of time series pressure distribution data pieces pertaining to persons other than the would-be registrant. For the sake of simplicity, the time series pressure distribution data piece pertaining to a person other than the would-be registrant may be referred to as a “time series pressure distribution data piece of other person”.

The preprocessor 20 uses the time series distribution data piece pertaining to the would-be registrant outputted from the data converter 15, as part of the set of training data.

The preprocessor 20 selects the entirety or part of the time series pressure distribution data pieces pertaining to a plurality of persons stored in the learning data storage unit 21, and uses the selected data pieces as the time series pressure distribution data pieces of other persons to be included in the set of training data (forming the remaining part of the set of training data). It is so arranged that when a time series pressure distribution data piece pertaining to the would-be registrant is included in the time series pressure distribution data pieces pertaining to the plurality of persons stored in the learning data storage unit 21}, the time series distribution data piece pertaining to the would-be registrant is not selected as one of the “time series pressure distribution data pieces of the other persons” mentioned above.

The preprocessor 20 also generates a set of training signals corresponding to the set of training data.

The preprocessor 20 causes the generated set of training data and the generated set of training signals, to be stored in the learning data storage unit 21.

The parameter storage unit 23 stores a set of parameters used for the computation in the feature computation unit 22. Initial values of the parameters are set at random, for example, and the values of the parameters are adjusted through feature computation and learning by the feature computation unit 22 and the learning unit 24, to be described later.

The feature computation unit 22 sequentially selects training data included in the set of training data generated by the preprocessor 20 and stored in the learning data storage unit 21, performs feature computation on the selected training data using the set of parameters stored in the parameter storage unit 23, and sequentially outputs the results of the computation.

For instance, if the number of time series pressure distribution data pieces pertaining to other persons is R, then R time series pressure distribution data pieces of other persons, and one time series pressure distribution data piece of the would-be registrant are sequentially input as the training data to the feature computation unit 22. The feature computation unit 22 performs feature computation on the (R+1) training data pieces which are sequentially input, using the set of parameters stored in the parameter storage unit, and sequentially outputs (R+1) results of the computation.

The feature computation performed by the feature computation unit 22 is for outputting a signal specifying the individual person based on the feature of the time series pressure distribution data piece of each would-be registrant. The set of parameters used for the computation is so adjusted through learning as to be optimum for the identification based on the feature of the time series pressure distribution data piece of each would-be registrant. The set of parameters at the time of completion of the adjustment (optimized set of parameters) will correspond to the feature of the time series pressure distribution data piece of each would-be registrant. Therefore, the process for optimizing the set of parameters by the feature computation unit 22 can be said to be a process for extracting the feature.

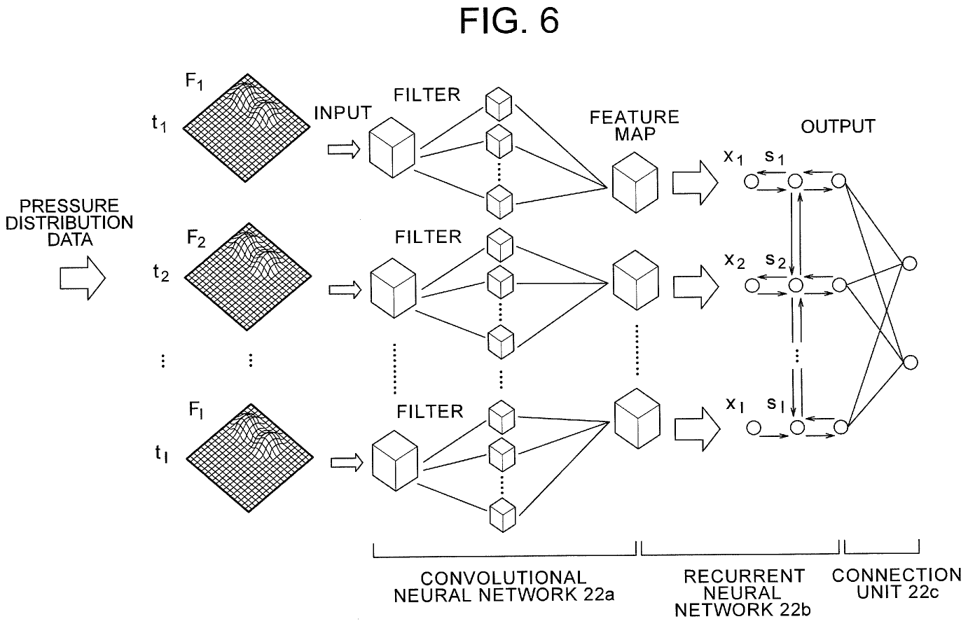

For the feature computation performed by the feature computation unit 22, a method using a neural network combining a convolutional neural network and a recurrent neural network is used. FIG. 6 shows an example of such a neural network.

In FIG. 6, F₁, F₂, . . . F_{I} respectively denote pressure distribution data at sampling timings t₁, t₂, . . . t_{I} (that is, pressure distribution data of the respective frames).

The convolutional neural network 22a includes at least one stage of a combination of a three-dimensional convolution layer and a pooling layer. FIG. 6 shows just one stage for simplicity of illustration. The convolution layer in each stage performs convolution using one or more filters (kernels) to output feature maps. The pooling layer in each stage performs pooling (subsampling) of the feature maps outputted from the convolution layer in the same stage.

The convolution layer in the first stage in the convolutional neural network 22a acquires the time series pressure distribution data piece and performs convolution on the three-dimensional data (pressure distribution data) of each of the frames F₁, F₂, . . . F_{I}. The convolution layer in each of second and subsequent stages performs convolution on the output of the pooling layer in the preceding stage.

The recurrent neural network 22b receives the feature maps outputted from the convolutional neural network 22a and performs recurrent processes to extract time series quantities.

The connection unit 22c connects the outputs of the recurrent neural network 22b.

The connection by the connection unit 22c is performed by weighted addition of the outputs of the recurrent neural network 22b. The connection unit 22c may have an input layer, and an output layer, and additionally, one or more hidden layers. FIG. 6 shows only an input layer and an output layer for simplicity of illustration. When the connection unit 22c has one or more hidden layers, the weighted addition is performed in a plurality of stages.

The output of the connection unit 22c is the output of the feature computation unit 22.

The convolutional neural network 22a performs computation for extracting physical features, whereas the recurrent neural network 22b performs computation for extracting behavioral features. The physical feature quantities are obtained from the data of each frame, in the time series pressure distribution data piece. The behavioral feature quantities are obtained from the time series of data (hence, the time series of the physical feature quantities).

Examples of the physical features include a position of the center of gravity, the positions of one or more local maximum values, and positional relations between the one or more local maxima. Also, the positions of the centers of gravity of respective divided regions formed by dividing the pressure sensor, and the relations between such centers of the gravity can also be used as the physical features.

Examples of the behavioral features include change (movement) in the position of the center of gravity, change (movement) in the positions of one or more local maxima, change (movement) in the positional relations between the one or more local maxima, change (movement) in the position of the center of gravity for each divided region, and relations between the changes (movement) in the various positions mentioned above.

The learning unit 24 adjusts the set of parameters through learning by the error back propagation method, based on the set of results of the computation by the feature computation unit 22, and the training signals stored in the learning data storage unit 21. That is, the learning unit 24 adjusts, through learning, the set of parameters based on the set of results of the computation sequentially outputted by the feature computation unit 22, and the set of training signals generated by the preprocessor 20 and stored in the learning data storage unit 21.

When the feature computation unit 22 is as shown in FIG. 4, the parameters to be adjusted include the parameters defining the weights of the synapse coupling (coupling between neurons) in the neural network, and the parameters defining the characteristics of the filters.

The adjustment of the set of parameters is so made that the difference E between the set of results of the computation and the set of training signals are reduced. The difference E between the set of results of the computation and the set of training signals are sometimes referred to as an “error in the results of the computation” or simply as an “error”.

The results of the computation outputted when the feature computation unit 22 performs feature computation on each of the training data include first and second values u, v.

The training signals corresponding to the first and second values u, v of the results of the computation on the time series pressure distribution data piece of the would-be registrant are respectively “1” and “0”, whereas the training signals corresponding to the first and second values u, v of the results of the computation on each of the time series distribution data pieces of a plurality of other persons are respectively “0” and “1”.

For example, the learning unit 24 determines, as the error E of the results of the computation, a square sum of differences between the first and second values u, v of the respective results of the computation included in the set of the results of the computation, and the corresponding training signals. That is, the learning unit 24 determines a square sum of differences between the first and second values u, v of the results of the feature computation on the time series pressure distribution data piece of the would-be registrant, and the corresponding training signals 1, 0, and differences between the first and second values u, v of the results of the feature computation on the respective ones of the time series distribution data pieces of a plurality of other persons, and the corresponding training signals 0, 1.

The results of the computation on the time series pressure distribution data piece of the would-be registrant are denoted by (u₀, v₀), and the results of the computation on the R time series pressure distribution data pieces of other persons are respectively denoted by (u₁, v₁), (u₂, v₂) . . . (u_{R}, v_{R}).

The error E of the results of the computation is determined for example by the following equation (1).

$$\begin{matrix}[ Mathematical Expression 1 ] & \\ E = {( {u}_{0} - 1 )}^{2} + {( {v}_{0} - 0 )}^{2} + {\sum }_{r = 1}^{R} \{ {( {u}_{r} - 0 )}^{2} + {( {v}_{r} - 1 )}^{2} \} & ( 1 )\end{matrix}$$

If the error E is larger than a predetermined threshold value (convergence decision threshold value) Eₜₕ, the learning unit 24 adjusts the set of the parameters stored in the parameter storage unit 23.

The adjustment of the set of parameters is so made as to reduce the error E.

The learning unit 24 causes the feature computation unit 22 to repeat the feature computation using the adjusted set of parameters. That is, the set of parameters stored in the parameter storage unit 23 is updated by the adjusted set of parameters, and the feature computation unit 22 performs the feature computation again using the updated set of parameters.

The feature computation by the feature computation unit 22 and the adjustment of the set of parameters by the learning unit 24 are repeated until the error E becomes sufficiently small. That is, they are repeated until the error E becomes equal to or smaller than the threshold value Eₜₕ (converges to within the threshold value Eₜₕ).

When the error E has converged to within the threshold value Eₜₕ, the set of parameters used for the particular computation is regarded as the set of parameters which can properly extract the feature of the time series distribution data piece of the would-be registrant.

When the error E has converged to within the threshold value Eₜₕ, the identification data generation unit 25 generates a personal identification data piece of the particular would-be registrant from the set of parameters used for the particular computation, and causes the personal identification data piece to be stored in the identification data storage unit 26.

The personal identification data piece of each would-be registrant is stored in association with information specifying the particular would-be registrant. That is, the personal identification data piece is registered. By the registration of the personal identification data piece, each would-be registrant becomes a registered user (registered person).

The above-described processes, namely the sitting of the would-be registrant, the measurement of the pressure distribution data by the pressure sensor 10, the generation of the time series pressure distribution data piece by the data converter 15, the generation of the set of training data and the set of training signals by the preprocessor 20, the feature computation by the feature computation unit 22, and the learning by the learning unit 24 are performed for each would-be registrant, the identification data generation unit 25 stores the set of parameters pertaining to each would-be registrant having been adjusted through learning, as the personal identification data piece in the identification data storage unit 26 in association with information specifying the would-be registrant.

For instance, M personal identification data pieces are stored in the identification data storage unit 26 for M would-be registrants. Of these, the m-th (m is any of 1 to M) personal identification data piece corresponds to the m-th would-be registrant, and is stored in association with information specifying the m-th would-be registrant.

The preprocessor 30 in the authentication apparatus 3 causes the time series pressure distribution data piece outputted from the data converter 15 when an authentication object person is seated, to be stored as authentication data, in the authentication data storage unit 31.

The personal identification unit 32 includes first to M-th identification value generation units 32-1 to 32-M. Here, M is equal to the number of the users (registered persons) registered in the identification data storage unit 26 in the registration apparatus 2. The first to M-th identification value generation units 32-1 to 32-M are respectively provided corresponding to the first to M-th registered persons.

The personal identification unit 32 reads the time series pressure distribution data piece pertaining to the authentication object person stored in the authentication data storage unit 31. The time series pressure distribution data piece pertaining to the authentication object person having been read is input to the first to M-th identification value generation units 32-1 to 32-M.

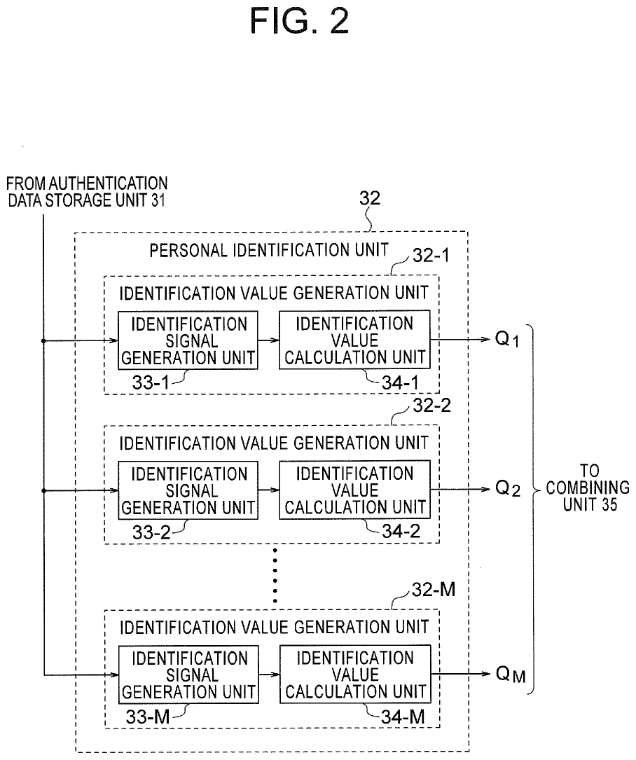

As shown in FIG. 2, the first to M-th identification value generation units 32-1 to 32-M respectively include identification signal generation units 33-1 to 33-M, and identification value calculation units 34-1 to 34-M. That is, the m-th (m being any of 1 to M) identification value generation unit 32-m includes an identification signal generation unit 33-m and an identification value calculation unit 34-m.

Each of the first to M-th identification signal generation units 33-1 to 33-M has the same configuration as the feature computation unit 22 in the registration apparatus 2, and performs the same feature computation as the feature computation performed by the feature computation unit 22. However, the set of parameters being used is different. That is, the personal identification data pieces pertaining to the first to M-th registered persons are respectively set as the sets of parameters in the first to M-th identification signal generation units 33-1 to 33-M, and the first to M-th identification signal generation units 33-1 to 33-M perform the feature computation respectively using the sets of parameters which are set therein.

The first to M-th identification value generation units 32-1 to 32-M are respectively constructed corresponding to the first to M-th registered persons. For example, each time the personal identification data piece of a would-be registrant is registered in the identification data storage unit 26, whereby the would-be registrant becomes a newly registered person (m-th registered person), an identification value generation unit (m-th identification value generation unit 32-m) corresponding to the newly registered person is constructed. The identification value generation unit is implemented by software.

Constructing the identification value generation unit (32-m) corresponding to a newly registered person includes constructing an identification signal generation unit (33-m) which has the same configuration as the feature computation unit 22, and in which the personal identification data piece of the newly registered person is set as the set of parameters, and constructing a corresponding identification value calculation unit (34-m).

When the feature computation unit 22 is formed of a neural network as exemplified in FIG. 6, the identification signal generation unit (33-m) is formed of a neural network which is identical to that of the feature computation unit 22, and in which corresponding personal identification data piece (personal identification data piece of the m-th registered person) is set as a set of parameters.

The identification value calculation unit (34-m) performs calculation of the equation (2) to be described later, and the first to M-th identification value calculation units 34-1 to 34-M have an identical configuration.

As has been described, the first to M-th identification value generation units 32-1 to 32-M in the personal identification unit 32 are automatically constructed based on the personal identification data piece stored in the identification data storage unit 26, so that the authentication apparatus 3 can also be regarded as being automatically generated based on the personal identification data piece stored in the identification data storage unit 26.

Each of the identification signal generation units 33-1 to 33-M outputs first and second identification signals respectively indicative of first and second values as the results of the feature computation. The first and second values are denoted by z₁, z₂. The two values z₁, z₂ correspond to the first and second values u, v included in the results of the feature computation by the feature computation unit 22.

Each (34-m) of the first to M-th identification value calculation units 34-1 to 34-M receives the first and second identification signals outputted by the corresponding identification signal generation unit 33-m, and calculates a personal identification value.

The personal identification value is denoted by Q.

Q is related to z₁, z₂, the relation being expressed by the following equation (2).

$$\begin{matrix}[ Mathematical Expression 2 ] & \\ Q = \frac{{z}_{1}}{{z}_{1} + {z}_{2}} & ( 2 )\end{matrix}$$

For distinction, the personal identification value outputted from the m-th identification value calculation unit 34-m is denoted by Qₘ. The personal identification value Qₘ is an index representing the probability or likelihood that the authentication object person is the m-th registered person.

The personal identification value Qₘ outputted from the m-th identification value calculation unit 34-m is supplied as the output of the m-th identification value generation unit 32-m, to the combining unit 35.

As has been described, the first to M-th identification value generation units 32-1 to 32-M are provided respectively corresponding to a plurality of registered persons, and each performs feature computation on the time series pressure distribution data piece pertaining to the authentication object person, using the personal identification data piece pertaining to the corresponding registered person as the set of parameters, calculates, from the result of the feature computation, the personal identification value representing the probability that the authentication object person is identical to the corresponding registered user, and outputs the calculated personal identification value.

If the authentication object person is the j-th registered person (j being any of 1 to M), when the time series pressure distribution data piece of the authentication object person is input to the first to M-th identification value generation units 32-1 to 32-M, then at the j-th identification value generation unit 32-j, z₁ will be relatively large and z₂ will be relatively small, so that the personal identification value Q will be relatively large, whereas at the identification value generation units other than the j-th identification value generation unit 32-j, z₁ will be relatively small, and z₂ will be relatively large, so that the personal identification value Q will be relatively small.

Then, among the personal identification values Q₁ to Q_{M} outputted from the first to M-th identification value generation units 32-1 to 32-M, the personal identification value Qⱼ outputted from the j-th identification value generation unit 32-j will be the largest.

If the authentication object person is not any of the first to M-th registered persons, when the time series pressure distribution data piece of the authentication object person is input to the first to M-th identification value generation units 32-1 to 32-M, at all of the identification value generation units, z₁ will be relatively small, and z₂ will be relatively large, so that the personal identification value Q will be relatively small.

The combining unit 35 combines the personal identification values Q₁ to Q_{M} outputted from the identification value generation units 32-1 to 32-M. In this combination, the combining unit 35 selects the largest one Qₘₐₓ of the personal identification values Q₁ to Q_{M}, and outputs the selected value.

The authentication decision unit 36 makes a determination as to whether the result of the combination, Qₘₐₓ, is larger than a predetermined threshold value (authentication threshold value) Qₜₕ (determination of authentication success, or authentication failure).

If the result of combination, Qₘₐₓ, is larger than the threshold value Qₜₕ, the authentication decision unit 36 makes a determination (determination of authentication success) that the authentication object person is the registered person (identical to the registered person) corresponding to the identification value generation unit which has outputted the personal identification value that is selected by the combining unit 35, and outputs the result of the determination.

If the output Qₘₐₓ of the combining unit 35 is not larger than the threshold value Qₜₕ, the authentication decision unit 36 makes a determination (determination of authentication failure) that the authentication object person is not identical to any of the M registered persons, and outputs the result of the determination.

The result of the determination may be displayed by a monitor not shown. In this case, when the result of determination of authentication failure is displayed, a notification may also be displayed for prompting the user to repeat the sitting, and receive the authentication again.

Also, the result of the determination may be used for control over other equipment. For instance, if the pressure sensor 10 is provided on a driver's seat in an automobile, it may be so configured that a determination of authentication success permits starting of the engine, whereas a determination of authentication failure prevents starting of the engine.

When a determination of authentication success is made, the authentication decision unit 36 supplies data representing the authentication result to the identification data updating unit 37. The data representing the authentication result includes data specifying the registered person having been found to be identical to the authentication object person.

Upon receiving the data representing the authentication result from the authentication decision unit 36, the identification data updating unit 37 causes the registration apparatus 2 to update the personal identification data piece of the registered person having been found to be identical to the authentication object person. This updating comprises updating of the personal identification data piece stored in the identification data storage unit 26, and is performed using the time series pressure distribution data piece pertaining to the authentication object person stored in the authentication data storage unit 3.

Specifically, the identification data updating unit 37 reads the time series pressure distribution data piece pertaining to the authentication object person stored in the authentication data storage unit 31, and supplies the time series pressure distribution data piece having been read, and information specifying the registered person having been found to be identical to the authentication object person, included in the data representing the authentication result, supplied from the authentication decision unit 36, to the preprocessor 20 in the registration apparatus 2.

The preprocessor 20 generates a set of training data (training data for updating) from the time series pressure distribution data piece pertaining to the authentication object person supplied from the identification data updating unit 37, and the time series pressure distribution data pieces pertaining to a plurality of persons, stored in the learning data storage unit 21. The generated set of training data comprises the time series distribution data piece pertaining to the authentication object person, supplied from the identification data updating unit 37, and a plurality of time series pressure distribution data pieces pertaining to persons other than the authentication object person. For the sake of simplicity, the time series pressure distribution data piece pertaining to a person other than the authentication object person may hereafter be referred to as a “time series pressure distribution data piece of other person”.

The preprocessor 20 selects part or the entirety of the time series pressure distribution data pieces pertaining a plurality of persons, stored in the learning data storage unit 21, and uses the selected data pieces as the time series pressure distribution data pieces of other persons to be included in the set of the training data (forming part of the set of the training data). It is so arranged that when a time series pressure distribution data piece pertaining to the authentication object person is included in the time series pressure distribution data pieces pertaining to the plurality of persons stored in the learning data storage unit 21, the time series distribution data piece pertaining to the authentication object person is not selected as one of the “time series pressure distribution data pieces of other persons” mentioned above.

In this way, the preprocessor 20 generates the set of training data. It also generates a set of training signals (training signals for updating) corresponding to the set of training data.

The values of the “training signals corresponding to the training data” are given by: (u, v)=(1, 0) for the time series distribution data piece of the authentication object person, and (u, v)=(0, 1) for the time series distribution data pieces of other persons.

The preprocessor 20 causes the set of the training data and the set of the training signals to be stored in the learning data storage unit 21.

At the time of starting the learning for the purpose of updating, it is desirable that the personal identification data piece pertaining to the registered person having been found to be identical to the authentication object person, stored in the identification data storage unit 26 be read and set as the initial set of parameters in the parameter storage unit 23. Alternatively, a set of parameters having randomly selected values may be set in the parameter storage unit 23.

The feature computation unit 22 sequentially selects the training data included in the set of training data for updating, generated in the preprocessor 20 and stored in the learning data storage unit 21, performs feature computation on the selected training data using the set of parameters stored in the parameter storage unit 23, and sequentially outputs the results of the computation.

The feature computation performed by the feature computation unit 22 in this occasion is identical to the feature computation performed by the feature computation unit 22 in the registration mode. However there is a difference in that the time series pressure distribution data piece of the would-be registrant is used in the registration mode, while the time series pressure distribution data piece of the authentication object person is used in the updating mode.

The learning unit 24 adjusts the set of parameters through learning based on the set of the results of the computation sequentially outputted by the feature computation unit 22, and the set of training signals for updating, generated by the preprocessor 20.

The learning performed in this occasion by the learning unit 24 is identical to the learning performed by the learning unit 24 in the registration mode. However, in the registration mode, the set of parameters which will become the personal identification data piece of the would-be registrant is adjusted through learning, while, in the updating mode, the set of parameters which will become the personal identification data piece of the registered person having been found to be identical to the authentication object person is adjusted through learning.

The identification data generation unit 25 updates the personal identification data piece which is among the personal identification data pieces stored in the identification data storage unit 26 and which pertains to the registered person having been found to be identical to the authentication object person, using the set of parameters adjusted by the learning unit 24. That is, the set of parameters having been adjusted by the learning unit 24 is written as a new personal identification data piece in the identification data storage unit 26.

This updating can be said to be re-registration of the personal identification data piece.

When the personal identification data piece stored in the identification data storage unit 26 is updated in the registration apparatus 2, the corresponding identification value generation unit in the authentication apparatus 3 is also updated. Specifically, the set of parameters in the identification signal generation unit in the corresponding identification value generation unit is updated using the updated personal identification data piece.

Next, the procedure of the processes in the personal authentication system of the present embodiment will be described with reference to flowcharts.

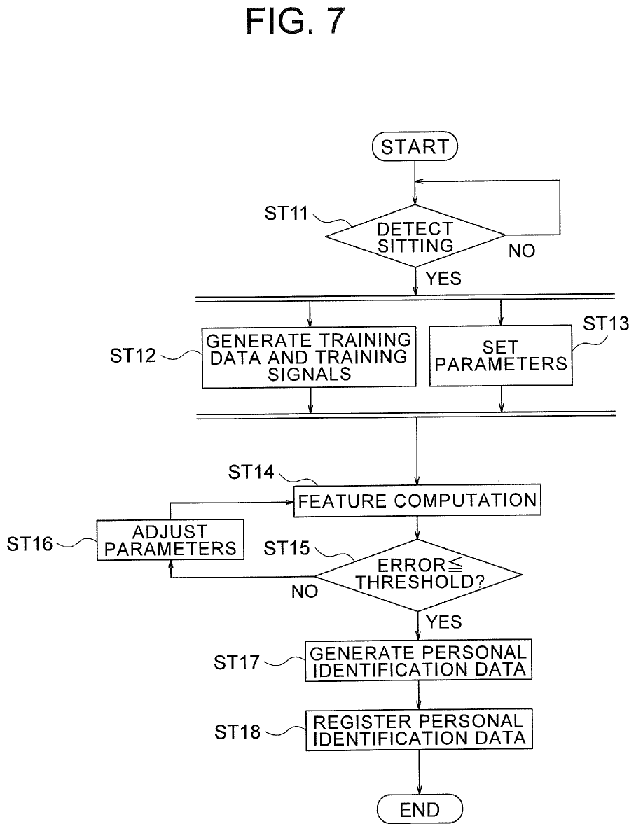

FIG. 7 is a flowchart showing the procedure of the processes in the registration mode in the personal authentication system of the present embodiment.

In the registration mode, the person who is to be registered (would-be registrant) sits on the chair 12 provided with the pressure sensor 10.

In step ST11, the data converter 15 detects the sitting of the would-be registrant.

Upon detection of the sitting, the data converter 15 starts measurement for the purpose of feature computation, and outputs a time series of pressure distribution data from the starting time point up to expiration of a preset measurement period, as a time series pressure distribution data piece.

Next, in step ST12, the preprocessor 20 combines the time series pressure distribution data piece outputted from the data converter 15 (time series pressure distribution data piece of the would-be registrant), with the time series pressure distribution data pieces of a plurality of other persons, selected from among the plurality of time series pressure distribution data pieces stored in the learning data storage unit 21, to generate a set of training data, generates a set of training signals corresponding to the set of training data, and causes the set of training data and the set of training signals to be stored in the learning data storage unit 21.

In step ST13, performed in parallel with step ST12, a set of parameters (initial set of parameters) having randomly selected values are stored in the parameter storage unit 23.

In step ST14, performed after steps ST12 and ST13, the feature computation unit 22 sequentially reads training data included in the set of training data from the learning data storage unit 21, performs feature computation on the read training data, and sequentially outputs the results of the computation. In the feature computation, the set of parameters stored in the parameter storage unit 23 are used.

In step ST15, the learning unit 24 compares the set of the results of the computation outputted from the above-mentioned feature computation unit with the set of training signals stored in the learning data storage unit 21, and determines whether the error E is equal to or less than the threshold value Eₜₕ.

If the error E is larger than the threshold value Eₜₕ, the procedure proceeds to step ST16.

In step ST16, the learning unit 24 adjusts the set of parameters stored in the parameter storage unit 23. The adjustment of the set of parameters is so made that the error E becomes smaller. The learning unit 24 writes the adjusted set of parameters in the parameter storage unit 23. That is, the set of parameters is updated.

After step ST16, the procedure returns to step ST14.

In step ST14, the feature computation unit 22 performs the feature computation again using the updated set of parameters, and outputs the results of the computation. In step ST15, the learning unit 24 compares the set of the results of computation with the set of training signals.

The above-described processes of steps ST14, ST15, ST16 are repeated until the error E is found to be equal to or smaller than the threshold value Eₜₕ in step ST15.

If, in step ST15, the error E is found be equal to or smaller than the threshold value Eₜₕ (has become sufficiently small), the procedure proceeds to step ST17.

In step ST17, the identification data generation unit 25 generates a personal identification data piece using the set of parameters at the time when the error E has become sufficiently small.

In step ST18, the identification data generation unit 25 causes the personal identification data piece generated in step ST17 to be stored in the identification data storage unit 26 in association with information specifying the particular would-be registrant, i.e., registers the personal identification data piece.

When the personal identification data piece is registered in the identification data storage unit 26 in the registration apparatus 2, an identification value generation unit corresponding to the registered personal identification data piece is constructed in the authentication apparatus 3.

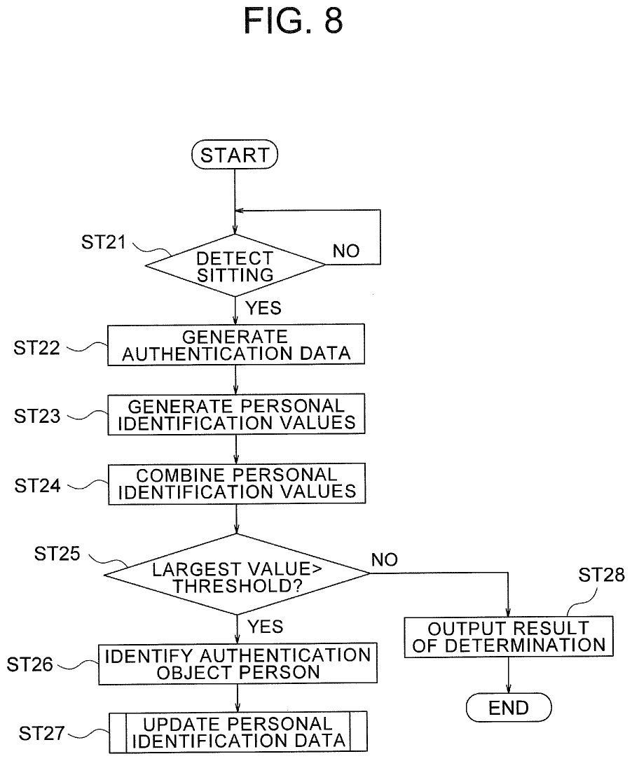

FIG. 8 is a flowchart showing the procedure of the processes in the personal authentication mode, in the personal authentication system of the present embodiment.

In the personal authentication mode, the person who is to receive personal authentication (authentication object person) sits on the chair 12 provided with the pressure sensor 10.

In step ST21, the data converter 15 detects the sitting of the authentication object person.

Upon detection of the sitting, the data converter 15 starts measurement for the purpose of generating the identification value, and outputs the time series of the pressure distribution data from the starting time point up to expiration of a preset period (measurement period), as a time series pressure distribution data piece.

In step ST22, the preprocessor 30 causes the time series pressure distribution data piece outputted from the data converter 15 to be stored as authentication data in the authentication data storage unit 31.

In step ST23, the personal identification unit 32 reads the time series pressure distribution data piece pertaining to the authentication object person from the authentication data storage unit 31, the identification value generation units 32-1 to 32-M in the personal identification unit 32 perform computation on the time series pressure distribution data piece pertaining to the authentication object person having been read, and output the personal identification values Q₁ to Q_{M} as the results of the computation.

In step ST24, the combining unit 35 combines the personal identification values Q₁ to Q_{M} outputted from the identification value generation units 32-1 to 32-M. The largest one Qₘₐₓ of the personal identification values Q₁ to Q_{M} is selected by this combining, and outputted.

In step ST25, the authentication decision unit 36 determines whether the output Qₘₐₓ of the combining unit 35 is larger than the threshold value Qₜₕ. If the output Qₘₐₓ of the combining unit 35 is larger than the threshold value Qₜₕ, the procedure proceeds to step ST26. Otherwise, the procedure proceeds to step ST28.

In step ST28, the authentication decision unit 36 makes a determination (authentication failure determination) that the authentication object person is none of the M registered persons, and outputs the result of the determination.

The result of the determination may be displayed on a monitor not shown. In this case, a notification may also be displayed to prompt the user to repeat the sitting and receive the authentication again.

If the user sits again, the processes in step ST21 and the following steps are repeated.

In step ST26, the authentication decision unit 36 makes a determination (authentication success determination) that the authentication object person is identical to the registered person corresponding to the identification value generation unit which has outputted the personal identification value selected by the combining unit 35, and outputs the result of the determination. The authentication decision unit 36 also supplies data indicating the authentication result to the identification data updating unit 37. The data indicating the authentication result includes data specifying the registered person having been found to be identical to the authentication object person.

In step ST27, the identification data updating unit 37 reads the time series pressure distribution data piece pertaining to the authentication object person stored in the authentication data storage unit 31, supplies the time series pressure distribution data piece having been read, and information specifying the registered person having been found to be identical to the authentication object person, included in the data indicating the authentication result supplied from the authentication decision unit 36, to the preprocessor 20 in the registration apparatus 2, and causes the registration apparatus 2 to update the personal identification data piece.

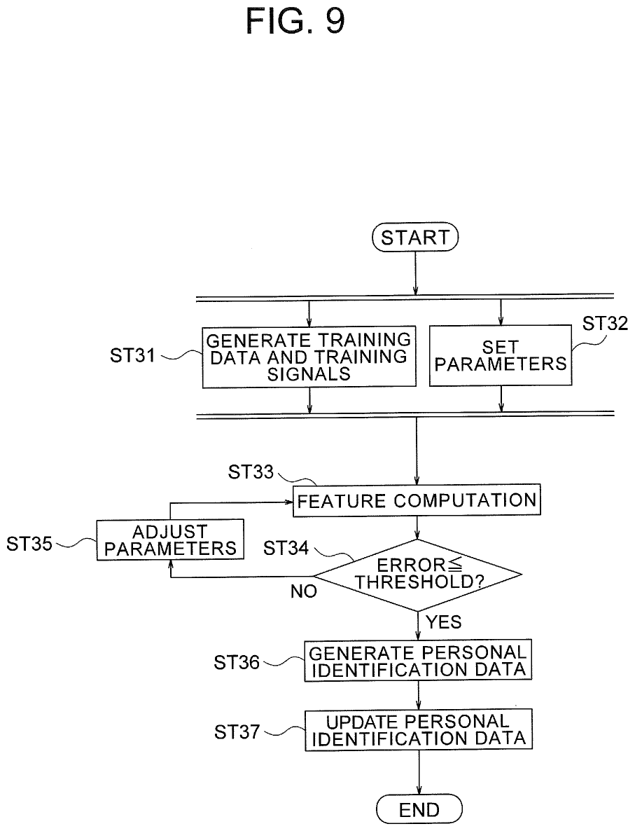

The processes for updating the personal identification data piece in step ST27 in FIG. 8 will now be described with reference to FIG. 9.

The updating of the personal identification data piece is started when the time series pressure distribution data piece of the authentication object person and the data specifying the registered person having been found to be identical to the authentication object person are supplied from the identification data updating unit 37.

In step ST31, the preprocessor 20 generates a set of training data from the time series pressure distribution data piece of the authentication object person supplied from the identification data updating unit 37, and the time series pressure distribution data pieces of a plurality of other persons selected from among the plurality of time series distribution data pieces stored in the learning data storage unit 21, also generates a set of training signals corresponding to the set of training data, and causes the set of training data and the set of training signals to be stored in the learning data storage unit 21.

In step ST32, performed in parallel with step ST31, a set of parameters is stored in the parameter storage unit 23. In this instance, it is desirable that the personal identification data piece pertaining to the registered person having been found to be identical to the authentication object person is set as an initial set of parameters in the parameter storage unit 23. Alternatively, a set of parameters having randomly selected values may be set.

In step ST33, after step ST31 and ST32, the feature computation unit 22 sequentially selects the training data included in the set of training data generated by the preprocessor 20, and stored in the learning data storage unit 21, performs feature computation on the selected training data using the set of parameters stored in the parameter storage unit 23, and sequentially outputs the results of the computation.

In step ST34, the learning unit 24 compares the set of the results of the computation outputted from the above-mentioned feature computation unit with the set of training signals stored in the learning data storage unit 21, and determines whether the error E is larger than the threshold value Eₜₕ.

If the error E is larger than the threshold value Eₜₕ, the procedure proceeds to step ST35.

In step ST35, adjustment on the set of parameters is performed, and the set of parameters stored in the parameter storage unit 23 is updated using the adjusted set of parameters.

After step ST35, the procedure returns to step ST33.

In step ST33, the feature computation unit 22 performs the feature computation again using the updated set of parameters. In step ST34, the learning unit 24 compares the set of the results of the computation with the set of training signals.

The above-mentioned processes in step ST33, ST34, ST35 are repeated until the error E is found to be equal to or smaller than the threshold value Eₜₕ in step ST34.

If, in step ST34, the error E is found to be equal to or smaller than the threshold value Eₜₕ (has become sufficiently small), the procedure proceeds to step ST36.

In step ST36, the identification data generation unit 25 generates a personal identification data piece using the set of parameters at the time when the error E has become sufficiently small.

In step ST37, the identification data generation unit 25 updates the data stored in the identification data storage unit 26 using the personal identification data piece generated in step ST36. For example, the personal identification data piece stored in the identification data storage unit 26 is overwritten with the newly generated personal identification data piece.

When the personal identification data piece in the identification data storage unit 26 is updated in the registration apparatus 2, the corresponding identification value generation unit in the authentication apparatus 3 is updated. Specifically, the set of parameters in the identification signal generation unit in the corresponding identification value generation unit is updated using the updated personal identification data piece.

### Second Embodiment

In the first embodiment, the measurement of the seat pressure of the would-be registrant (acquisition of the time series pressure distribution data piece) is performed once, and a set of training data is generated from a single time series pressure distribution data piece pertaining to the would-be registrant, and a plurality of time series pressure distribution data pieces pertaining to persons (other persons) other than the would-be registrant.

Alternatively, the measurement of the seat pressure of the would-be registrant (acquisition of the time series pressure distribution data piece) may be performed a plurality of times, and a set of training data may be generated from a plurality of time series distribution data pieces pertaining to the would-be registrant, and a plurality of time series distribution data pieces pertaining to persons (other persons) other than the would-be registrant. For example, if N time series pressure distribution data pieces pertaining to the would-be registrant are used, a set of training data is generated from the N time series pressure distribution data pieces and the R time series pressure distribution data pieces of other persons, the training data included in the set of training data are sequentially selected, and the feature computation in the feature computation unit 22 is performed, and N+R results of the computation are sequentially outputted. In such a case, the computation of the error E is performed according to the following equation (3).

$$\begin{matrix}[ Mathematical Expression 3 ] & \\ E = {\sum }_{n = 1}^{N} \{ {( {u}_{0 n} - 1 )}^{2} + {( {v}_{0 n} - 0 )}^{2} \} + {\sum }_{r = 1}^{R} \{ {( {u}_{r} - 0 )}^{2} + {( {v}_{r} - 1 )}^{2} \} & ( 3 )\end{matrix}$$

In equation (3), (u₀ₙ, v₀ₙ) denotes the result of the computation on the n-th time series pressure distribution data piece (n being any of 1 to N) pertaining to the would-be registrant.

When the plurality of time series pressure distribution data pieces stored in the learning data storage unit 21 include a time series pressure distribution data piece pertaining to the would-be registrant, such a time series pressure distribution data piece pertaining to the would-be registrant may be used as a “time series distribution data piece pertaining to the would-be registrant” to be included in the training data.

In such a case, the time series pressure distribution data piece pertaining to the would-be registrant included in the plurality of time series pressure distribution data pieces stored in the learning data storage unit 21 may be treated identically with (or as part of) the time series pressure distribution data pieces (the above-mentioned N time series pressure distribution data pieces) pertaining to the would-be registrant acquired by the above-mentioned new measurement.

### Third Embodiment.

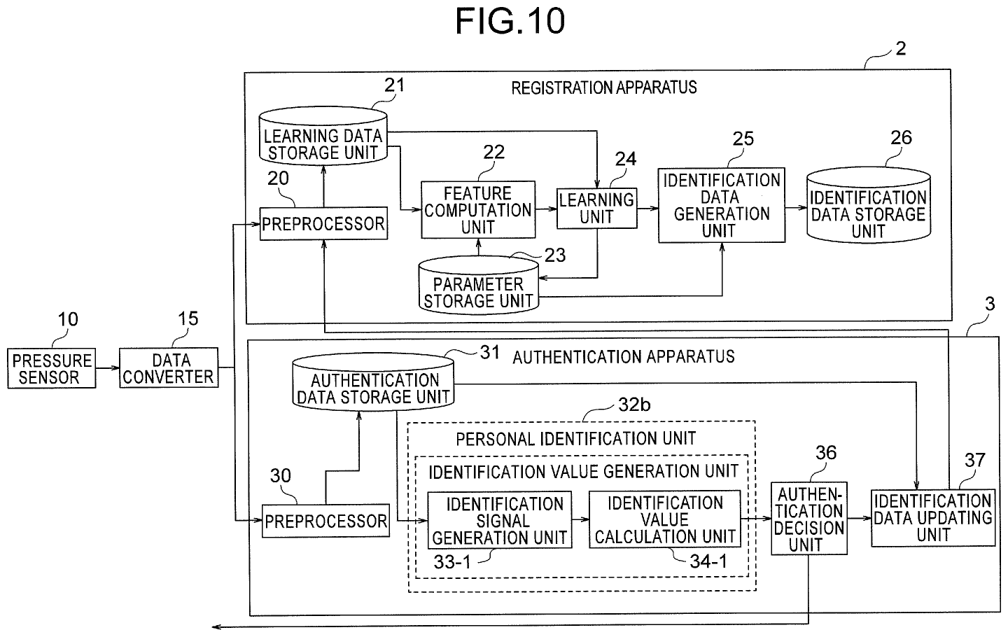

In the first embodiment, the identification data storage unit 26 in the registration apparatus 2 registers a plurality of users, and the personal identification unit 32 in the authentication apparatus includes a plurality of identification value generation units. However, the present invention is also applicable where the identification data storage unit 26 in the registration apparatus 2 registers a single user, and the personal identification unit 32 in the authentication apparatus comprises a single identification value generation unit. An example of configuration of the personal authentication system in such a case is shown in FIG. 10.

The personal authentication system shown in FIG. 10 is generally identical to the personal authentication system shown in FIG. 1. However, instead of the identification data storage unit 26 and the personal identification unit 32 in FIG. 1, an identification data storage unit 26b and a personal identification unit 32b are provided, and the combining unit 35 in FIG. 1 is not provided.

The identification data storage unit 26b is generally identical to the identification data storage unit 26, but differs in that it stores just one identification data piece.

The personal identification unit 32b is generally identical to the personal identification unit 32, but differs in that it has just one identification value generation unit.

In FIG. 10, the output of the single identification value generation unit 32-1 is input to the authentication decision unit 36.

The identification value generation unit 32-1 includes an identification signal generation unit 33-1 and an identification value calculation unit 34-1.

In this configuration, the identification signal generation unit 33-1 performs feature computation on the time series pressure distribution data piece pertaining to the authentication object person using, as the set of parameters, the personal identification data piece pertaining to the user registered in the identification data storage unit 26, to generate first and second identification signals having first and second values z₂.

The identification value calculation unit 34-1 calculates the personal identification value Q based on the first and second identification signals generated by the identification signal generation unit 33-1, and outputs the calculated value. The personal identification value Q represents the probability that the authentication object person is (identical to) the registered user. The personal identification value Q calculated by the identification value calculation unit 34-1 is supplied as the output of the identification value generation unit 32-1 to the authentication decision unit 36.

If the personal identification value Q outputted from the identification value generation unit 32-1 is larger than the threshold value Qₜₕ, the authentication decision unit 36 determines that the authentication object person is identical to the registered user. If the personal identification value Q outputted from the identification value generation unit 32-1 is not larger than the threshold value Qₜₕ, the authentication decision unit 36 determines that the authentication object person is not identical to the registered user.

Apart from the above differences, the operation of the personal identification system of the third embodiment is similar to that of the personal authentication system of the first embodiment, and effects obtained by the third embodiment are similar to those of the first embodiment.

As has been described, according to the above-described embodiments, the personal identification data piece is automatically generated through learning in the registration apparatus, and it is possible to automatically generate an authentication apparatus which performs personal authentication using the personal identification data piece registered in the registration apparatus. Also, it is possible to perform personal authentication which takes account of the physical feature and the behavioral feature, and which is robust against the motion of the user at the time of measurement.

The present invention has been described as a registration apparatus, an authentication apparatus and a personal authentication system. However, a registration method, an authentication method, and a personal authentication method implemented in the above described registration apparatus, authentication apparatus and personal authentication system also form part of the present invention.

Description has been made on the embodiments of the present invention. However, the present invention is not limited to the embodiments described above, and various modifications are possible within the scope of the present invention which is set forth in the claims.

### REFERENCE CHARACTERS

2: registration apparatus; 3: authentication apparatus; 10: pressure sensor; 15: data converter; 20: preprocessor; 21: learning data storage unit; 22: feature computation unit; 22a: convolutional neural network; 22b: recurrent neural network; 22c: connection unit; 23: parameter storage unit; 24: learning unit; 25: identification data generation unit; 26, 26b: identification data storage unit; 30: preprocessor; 31: authentication data storage unit; 32, 32b: personal identification unit; 32-1 to 32-M: identification value generation unit; 33-1 to 33-M: identification signal generation unit; 34-1 to 34-M: identification value calculation unit; 53: combining unit; 36: authentication decision unit; 37: identification data updating unit.

1. A registration apparatus comprising:
a pressure sensor disposed on a seat surface on which a person sits, and detecting distribution of pressure applied on the seat surface, and outputting pressure distribution data of respective frames;
a data converter for outputting a time series of the pressure distribution data of respective frames outputted from the pressure sensor, as a time series pressure distribution data piece; and
processing circuitry
to store time series pressure distribution data pieces pertaining to a plurality of randomly selected persons;
to generate a set of training data, using, as the training data, a time series pressure distribution data piece pertaining to a user to be registered, and a plurality of time series pressure distribution data pieces pertaining to persons other than the user to be registered, among the stored time series pressure distribution data pieces pertaining to the plurality of randomly selected persons, to also generate a set of training signals corresponding to the set of training data;
to store a set of parameters;
to sequentially select the training data included in the set of training data, to perform feature computation on the selected training data, using the stored set of parameters, to sequentially produce results of the computation;
to adjust, through learning, the stored set of parameters based on a set of the sequentially produced results of the computation, and the set of training signals;
to generate a personal identification data piece pertaining to the user from the adjusted set of parameters; and
to store the generated personal identification data piece, in association with information specifying the user, thereby to register the user; wherein
the feature computation includes computation for extracting a physical feature from the pressure distribution data of each frame, and computation for extracting a behavioral feature from the time series of the pressure distribution data.

2. The registration apparatus as set forth in claim 1, wherein
the generation of the set of training data and the set of training signals, the feature computation and the learning are performed for each of a plurality of users to be registered, the adjusted set of parameters pertaining to each user is stored as a personal identification data piece in association with information specifying said each user, and
personal identification data pieces pertaining to a plurality of users are stored, whereby said plurality of users are registered.

3. The registration apparatus as set forth in claim 1, wherein the processing circuitry includes a convolutional neural network and a recurrent neural network, the convolutional neural network performs the computation for extracting the physical feature, and the recurrent neural network performs the computation for extracting the behavioral feature.

4. The registration apparatus as set forth in claim 1, wherein, when a difference between the set of the sequentially produced results of the computation and the set of training signals is larger than a predetermined convergence decision threshold value, the processing circuitry adjusts the stored set of parameters, and repeats the feature computation using the adjusted set of parameters.

5. The registration apparatus as set forth in claim 4, wherein when the processing circuitry determines that the difference between the set of the sequentially produced results of the computation and the set of training signals is not larger than the convergence decision threshold value, the processing circuitry causes the set of parameters having been used for the particular computation to be stored as the personal identification data piece of the particular user.

6. An authentication apparatus comprising:
processing circuitry to perform feature computation on a time series pressure distribution data piece pertaining to an authentication object person, using, as a set of parameters, the personal identification data piece pertaining to the user registered in the registration apparatus as set forth in claim 1, to calculate, from a result of the feature computation, a personal identification value representing probability that the authentication object person is identical to the registered user, and to determine that the authentication object person is identical to the registered user, when the calculated personal identification value is larger than a predetermined authentication threshold value,
the feature computation performed by the processing circuitry in the authentication apparatus being identical to the feature computation performed by the processing circuitry in the registration apparatus.

7. The authentication apparatus as set forth in claim 6, wherein
the result of the feature computation by the processing circuitry in the authentication apparatus includes first and second values, and
when the first and second values are denoted by z₁, z₂, and the personal identification value is denoted by Q, the calculation of the personal identification value is performed by:
$$Q = \frac{{z}_{1}}{{z}_{1} + {z}_{2}} \qquad [ Mathematical Expression 4 ]$$

8. The authentication apparatus as set forth in claim 6, wherein the processing circuitry in the authentication apparatus causes the registration apparatus to update the personal identification data piece of the registered user, when the authentication object person is determined to be identical to the registered user.

9. A personal authentication system comprising the registration apparatus as set forth in claim 1, and an authentication apparatus comprising:
processing circuitry to perform feature computation on a time series pressure distribution data piece pertaining to an authentication object person, using, as a set of parameters, the personal identification data piece pertaining to the user registered in the registration apparatus, to calculate, from a result of the feature computation, a personal identification value representing probability that the authentication object person is identical to the registered user, and to determine that the authentication object person is identical to the registered user, when the calculated personal identification value is larger than a predetermined authentication threshold value,
the feature computation performed by the processing circuitry in the authentication apparatus being identical to the feature computation performed by the processing circuitry in the registration apparatus.

10. A personal authentication system comprising the registration apparatus as set forth in claim 1, and an authentication apparatus comprising:
processing circuitry to perform feature computation on a time series pressure distribution data piece pertaining to an authentication object person, using, as a set of parameters, the personal identification data piece pertaining to the user registered in the registration apparatus, to calculate, from a result of the feature computation, a personal identification value representing probability that the authentication object person is identical to the registered user, and to determine that the authentication object person is identical to the registered user, when the calculated personal identification value is larger than a predetermined authentication threshold value,
the feature computation performed by the processing circuitry in the authentication apparatus being identical to the feature computation performed by the processing circuitry in the registration apparatus, wherein
the processing circuitry in the authentication apparatus causes the registration apparatus to update the personal identification data piece of the registered user, when the authentication object person is determined to be identical to the registered user, wherein
the processing circuit in the authentication apparatus outputs the time series pressure distribution data piece pertaining to the authentication object person,
the processing circuitry in the registration apparatus generates a set of training data for updating, using, as the training data, the outputted time series pressure distribution data piece pertaining to the authentication object person, and a plurality of time series pressure distribution data pieces pertaining to persons other than the authentication object person, among the stored time series pressure distribution data pieces pertaining to the plurality of randomly selected persons, and generates a set of training signals for updating, corresponding to the set of training data,
sequentially selects the training data included in the set of training data for updating, performs feature computation on the selected training data, using the stored set of parameters, sequentially produces results of the computation,
adjusts, through learning, the stored set of parameters, based on a set of the sequentially produced results of the computation on the training data for updating, and the set of training signals for updating, and
updates the stored personal identification data piece using the adjusted set of parameters.

11. The personal authentication system as set forth in claim 10, wherein
the processing circuitry in the registration apparatus starts the feature computation on the training data included in the set of training data for updating, in a state in which the personal identification data piece is stored as the set of parameters.

12. An authentication apparatus comprising:
processing circuitry to generate identification values for the plurality of users registered in the registration apparatus as set forth in claim 2, the generation of the identification values being performed using the personal identification data pieces respectively pertaining to the registered users, wherein the processing circuitry in the authentication apparatus performs feature computation on a time series pressure distribution data piece pertaining to an authentication object person, using, as a set of parameters, the personal identification data piece pertaining to the corresponding registered user, calculates, from a result of the feature computation, a personal identification value representing probability that the authentication object person is identical to the corresponding registered user,
selects a largest one of the calculated personal identification values; and
determines that the authentication object person is identical to the registered user corresponding to the identification data piece used for the generation of the largest one of the calculated personal identification values, when the largest one of the calculated personal identification values is larger than a predetermined authentication threshold value,
the feature computation performed by the processing circuitry in the authentication apparatus being identical to the feature computation performed by the processing circuitry in the registration apparatus.

13. The authentication apparatus as set forth in claim 12, wherein
the result of the feature computation by the processing circuitry in the authentication apparatus includes first and second values, and
when the first and second values are denoted by z₁, z₂, and the personal identification value is denoted by Q, the calculation of the personal identification value is performed by:
$$Q = \frac{{z}_{1}}{{z}_{1} + {z}_{2}} \qquad [ Mathematical Expression 5 ]$$

14. The authentication apparatus as set forth in claim 12, wherein when the authentication object person is determined to be identical to the registered user corresponding to the identification data piece used for the generation of the largest one of the calculated personal identification values, the processing circuitry in the authentication apparatus causes the registration apparatus to update the personal identification data piece of the registered user who has been determined to be identical to the authentication object person.

15. A personal authentication system comprising the registration apparatus as set forth in claim 2, and an authentication apparatus comprising:
processing circuitry to generate identification values for the plurality of users registered in the registration apparatus,
the generation of the identification values being performed using the personal identification data pieces respectively pertaining to the registered users, wherein the processing circuitry in the authentication apparatus performs feature computation on a time series pressure distribution data piece pertaining to an authentication object person, using, as a set of parameters, the personal identification data piece pertaining to the corresponding registered user, calculates, from a result of the feature computation, a personal identification value representing probability that the authentication object person is identical to the corresponding registered user,
selects a largest one of the calculated personal identification values; and
determines that the authentication object person is identical to the registered user corresponding to the identification data piece used for the generation of the largest one of the calculated personal identification values, when the largest one of the calculated personal identification values is larger than a predetermined authentication threshold value,
the feature computation performed by the processing circuitry in the authentication apparatus being identical to the feature computation performed by the processing circuitry in the registration apparatus.

16. A personal authentication system comprising the registration apparatus as set forth in claim 2, and an authentication apparatus comprising:
processing circuitry to generate identification values for the plurality of users registered in the registration apparatus,
the generation of the identification values being performed using the personal identification data pieces respectively pertaining to the registered users, wherein the processing circuitry in the authentication apparatus performs feature computation on a time series pressure distribution data piece pertaining to an authentication object person, using, as a set of parameters, the personal identification data piece pertaining to the corresponding registered user, calculates, from a result of the feature computation, a personal identification value representing probability that the authentication object person is identical to the corresponding registered user,
selects a largest one of the calculated personal identification values; and
determines that the authentication object person is identical to the registered user corresponding to the identification data piece used for the generation of the largest one of the calculated personal identification values, when the largest one of the calculated personal identification values is larger than a predetermined authentication threshold value,
the feature computation performed by the processing circuitry in the authentication apparatus being identical to the feature computation performed by the processing circuitry in the registration apparatus, wherein
when the authentication object person is determined to be identical to the registered user corresponding to the identification data piece used for the generation of the largest one of the calculated personal identification values, the processing circuitry in the authentication apparatus causes the registration apparatus to update the personal identification data piece of the registered user who has been determined to be identical to the authentication object person, wherein
the processing circuit in the authentication apparatus outputs the time series pressure distribution data piece pertaining to the authentication object person, and information specifying the registered user who has been determined to be identical to the authentication object person,
the processing circuitry in the registration apparatus generates a set of training data for updating, using, as the training data, the outputted time series pressure distribution data piece pertaining to the authentication object person, and a plurality of time series pressure distribution data pieces pertaining to persons other than the authentication object person, among the stored time series pressure distribution data pieces pertaining to the plurality of randomly selected persons, and generates a set of training signals for updating, corresponding to the set of training data,
sequentially selects the training data included in the set of training data for updating, performs feature computation on the selected training data, using the stored set of parameters, and sequentially produces results of the computation,
adjusts, through learning, the stored set of parameters, based on a set of sequentially produced results of the computation on the training data for updating, and the set of training signals for updating, and
updates the personal identification data piece pertaining to the registered user, who has been determined to be identical to the authentication object person, among the stored personal identification data pieces, using the adjusted set of parameters.

17. The personal authentication system as set forth in claim 16, wherein
the processing circuitry in the registration apparatus starts the feature computation on the training data included in the set of training data for updating, in a state in which the personal identification data piece pertaining to the registered user who has been determined to be identical to the authentication object person, among the stored personal identification data pieces is stored as the set of parameters.

18. A personal authentication method for performing personal authentication based on a time series pressure distribution data piece comprising a time series of pressure distribution data of respective frames obtained by detecting distribution of pressure applied on a seat surface on which a person sits, the method comprising:
storing time series pressure distribution data pieces pertaining to a plurality of randomly selected persons;
generating a set of training data using, as the training data, a time series pressure distribution data piece pertaining to a user to be registered, and a plurality of time series pressure distribution data pieces pertaining to persons other than the user to be registered among the stored time series pressure distribution data pieces pertaining to the plurality of randomly selected persons;
generating a set of training signals corresponding to the set of training data;
storing a set of parameters;
sequentially selecting the training data included in the set of training data,
performing feature computation on the selected training data, using the stored set of parameters, to sequentially generate results of the computation;
adjusting, through leaning, the stored set of parameters based on a set of the sequentially generated results of the computation, and the set of training signals;
storing the adjusted set of parameters as a personal identification data piece of the user, in association with information specifying the user, thereby to register the user;
the feature computation including computation for extracting a physical feature from the pressure distribution data of each frame, and computation for extracting a behavioral feature from the time series of the pressure distribution data,
performing feature computation identical to the feature computation performed on the training data, on a time series pressure distribution data piece pertaining to an authentication object person, using the personal identification data piece pertaining to the registered user as a set of parameters;
calculating, from a result of the feature computation, a personal identification value representing probability that the authentication object person is identical to the registered user; and
determining that the authentication object person is identical to the registered user, when the calculated personal identification value is larger than a predetermined authentication threshold value.

19. (canceled)

20. A non-transitory computer-readable recording medium in which a program for causing a computer to execute the processes in the personal authentication method as set forth in claim 18 is stored.
